(19) United States
(12) Patent Application Publication
(10) Pub. No.: US 2019/0343600 A1
(43) Pub. Date: Nov. 14, 2019

(54) Dental Bur Caddy

(71) Applicant: Nancy Yee, Santa Monica, CA (US)

(72) Inventor: Nancy Yee, Santa Monica, CA (US)

(21) Appl. No.: 15/973,973

(22) Filed: May 8, 2018

(51) Int. Cl. A61C 3/06; A61C 19/02

(52) U.S. Cl. CPC A61C 3/06; A61C 19/02

(57) ABSTRACT

An improved dental bur caddy with a body portion slidably and rotatably connected to a handle portion. The body portion includes a top portion having a plurality of bur holders and the handle portion is concave to cover the top portion. The handle portion is slidable between an open and a closed configuration, and is rotatable between a first position above the top portion, and a second position, wherein in the second position, the handle portion forms a stand configured to hold the top portion in an orientation selected by a user. The apparatus preferably includes a plurality of handle portals in the handle member, wherein each of the plurality of handle portals is configured for viewing a dental bur in each of the bur holders.

### BACKGROUND

The present apparatus relates generally to dental surgery. More specifically, the present invention relates to a dental caddy for storing, using, replacing and cleaning dental burs.

Carbide, diamond and similar dental burs are small grinding tools used in dental procedures for removing material and tooth structure. While multiple dental burs in a kit have differently shaped heads (e.g., taper, fissure, barrel, cone, etc.) and necks, the shank of each dental bur is typically a uniform diameter and length. Thus several burs can be used with a single dental drill. Because several different sizes and shapes of burs may be necessary during a given dental procedure, dental bur blocks or ‘caddies’ were developed to hold a kit of dental burs together in an easily accessible location.

Dental caddies as they are currently known in the art have several drawbacks. First, they typically provide only a uniform series of evenly spaced shank holes, which can make organizing and identifying a particular bur among many inconvenient. Second, dental caddies known in the art typically present only a handle or similar structure functioning as a stand for holding the caddy, which may allow expensive dental burs to work their way out and be lost when inadvertently dislodged from the dental caddy during use or transport. Third, due to such minimal coverage, conventional dental caddies expose dental burs to the open air after removal from an autoclave package. Due to this exposure, the dental burs are more prone to collect dust or other contaminants that may create a disease transmission risk for the patient.

Hence, what is needed is an improved dental bur caddy that provides easily identifiable shank holes for more organized bur storage, and which provides greater coverage to prevent loss or contamination of the dental burs when prepared for use.

### SUMMARY

In a first embodiment, the improved apparatus may be characterized as a dental caddy for holding dental burs, having a body portion with a front face and an opposing rear face, the body portion coupled to a handle portion. The handle portion includes a spanning member located between a first arm and an opposing second arm, the first arm and the second arm are both coupled to the body portion, and the spanning member is at least partially concave in profile. The body portion also includes a first side and an opposing second side, wherein the first arm of the handle portion is coupled to the first side in a sliding and rotational configuration, and wherein the second arm of the handle portion is coupled to the second side in a sliding and rotational configuration.

The body portion also includes a top portion having bur holders configured for holding the dental burs, and a plurality of handle portals are positioned in the spanning member. Each of the handle portals is preferably configured such that a dental bur in each of the bur holders can be individually viewed from outside the dental caddy. Because the handle portion is configured to slide away from the body portion and rotate relative thereto, the handle portion forms a stand for holding up the body portion and presenting exposed and accessible dental burs to a user.

The first arm and the second arm may be are arranged substantially perpendicular to the spanning member, and are preferably, but not necessarily each as wide as the first side and the second side, respectively. The front face and the rear face each comprise hand grips for easily manipulating the dental caddy, and a series of body portals are located in the body portion, disposed opposite the spanning member for draining the body portion. The handle portion may include rounded corners corresponding to rounded edges of the first side and the second side. To hold the handle portion in place, at least one tab extends above the top portion and is configured to span the concave portion of the spanning member. Preferably the first arm and the second arm each comprise a slot, which is configured to allow the body portion to simultaneously slide along each slot, and the bur holders are preferably arranged in rows, with one row elevated above the other row.

In another preferable embodiment, the improvement may be characterized as an improved dental caddy for holding dental burs, wherein the dental caddy includes a body portion and a handle portion, with the body portion and the handle portion configured in a slidable relationship relative to each other and wherein they are slidable between a closed configuration and an open configuration. The body portion also includes a front face and an opposing rear face, and the handle portion has a front side and a rear side, wherein the front side is adjacent the front face and the rear side is adjacent the rear face when the dental caddy is in the closed configuration.

The handle portion includes a concave spanning member between a first arm and an opposing second arm, the first arm and the second arm being coupled to the body portion. The body portion also includes a first side and an opposing second side, with the first arm adjacent the first side and the second arm adjacent the second side. A top portion having bur holders configured for holding the dental burs is part of the body portion, and a plurality of handle portals are formed in the spanning member. Preferably, each of the plurality of handle portals is configured for viewing a dental bur in each of the bur holders, wherein the handle portion is configured to slide away from the body portion and rotate relative to it to form a stand for holding up the body portion and presenting exposed dental burs to a user.

Like the first embodiment, in the second embodiment, the first arm and the second arm may be arranged substantially perpendicular to the spanning member, each as wide as the first side and the second side, respectively. The front face and the rear face may each comprise hand grips. Additionally, a series of body portals may be disposed in the body portion, the body portals opposite the spanning member, and the handle portion may have rounded corners corresponding to rounded edges of the first side and second side. To secure the handle portion at least one tab preferably extends above the top portion and is configured to span the concave portion of the spanning member. For opening and closing, the first arm and the second arm may each include a slot configured for allowing the body portion to simultaneously slide along each slot. Preferably, the bur holders are arranged in rows, with one row elevated above the other row.

In yet another preferable embodiment, the apparatus may be characterized as an improved dental caddy for holding dental burs, wherein the dental caddy includes a body portion slidably and rotatably connected to a handle portion. The body portion includes a top portion comprising a plurality of bur holders, and the handle portion has a concave spanning member configured to cover the top portion. The handle portion is slidable between a closed configuration, wherein the spanning member covers the top portion, thereby enclosing the dental burs, and an open configuration, wherein the dental burs are exposed, and the handle portion is rotatable between a first position above the top portion, and a second position, wherein in the second position, the handle portion forms a stand configured to hold the top portion in an orientation selected by a user. In this configuration, the apparatus preferably includes a plurality of handle portals in the spanning member, wherein each of the plurality of handle portals is configured for viewing a dental bur in each of the bur holders.

### BRIEF DESCRIPTION OF THE FIGURES

FIG. 1 illustrates a front perspective view of an improved dental caddy in a closed configuration;

FIG. 2 illustrates a rear perspective view of the dental caddy in the closed configuration;

FIG. 3 illustrates a front elevation view of the dental caddy in the closed configuration;

FIG. 4 illustrates a rear elevation view of the dental caddy in the closed configuration;

FIG. 5 illustrates a side elevation view of the dental caddy in the closed configuration;

FIG. 6 illustrates a top elevation view of the dental caddy in the closed configuration;

FIG. 7 illustrates a front perspective view of an improved dental caddy in an open configuration;

FIG. 8 illustrates a rear perspective view of the dental caddy in the open configuration;

FIG. 9 illustrates a side elevation view of the dental caddy in the open configuration;

FIG. 10 illustrates a perspective view of the dental caddy in a first dispensing configuration; and

FIG. 11 illustrates a perspective view of the dental caddy in a second dispensing configuration.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

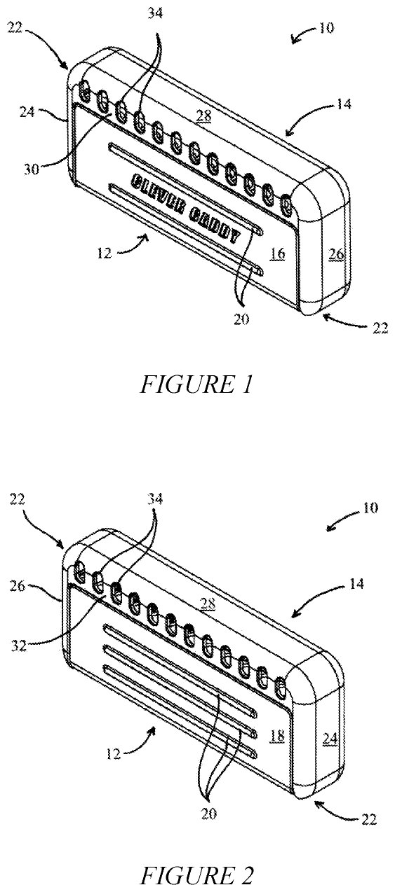

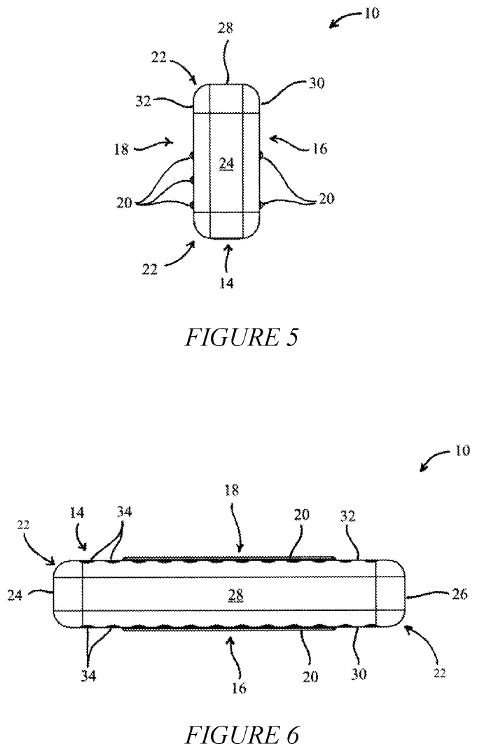

Referring to FIGS. 1-6, the improved dental bur caddy 10 is shown in a closed configuration. The principally comprises a body portion 12 and a handle portion 14. The body portion 12 includes a front face 16 and a rear face 18. The front face 16 and rear face 18 may include hand grips 20 for effective grasping and manipulation of the dental caddy 10. The handle portion 14 is preferably a u-shaped member, which surrounds the body portion 12 on three sides. In one exemplary embodiment, the handle portion includes rounded corners 22, to present a smooth profile when in a closed configuration.

The handle portion 14 includes a first arm 24 and a second arm 26, connected by a spanning member 28. The first arm 24 and the second arm 26 are each preferably connected to the spanning member 28 at a substantially forty-five degree angle. Thus, the handle portion 14 surrounds the body portion 12 on three sides when the dental bur caddy 10 is an the illustrated closed configuration. The spanning member 28 has a front side 30 and a rear side 32, preferably corresponding to the front face 16 and the rear face 18 of the body portion 12.

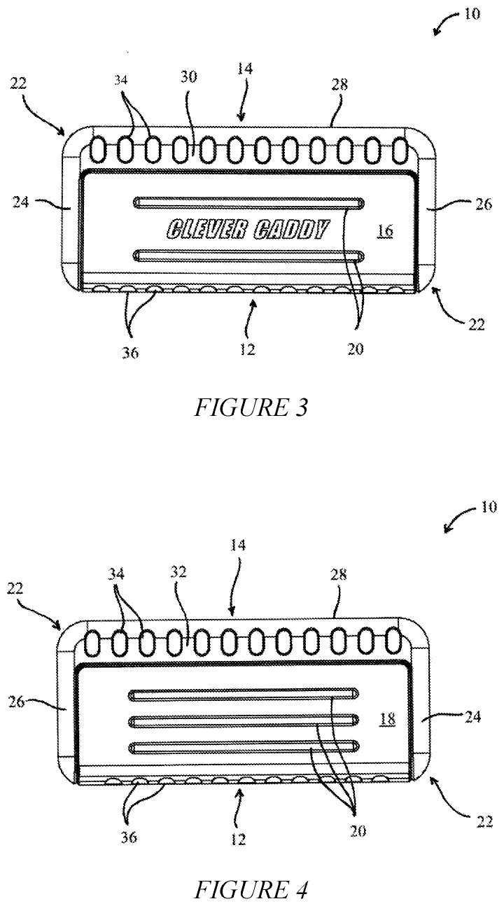

The spanning member 28 also includes a series of handle portals 34 preferably arranged in rows, one being disposed along the front side 30 and another disposed along the rear side 32 such that the handle portals 34 line up as shown in FIGS. 3 and 4. The handle portals 34 allow a user to identify the dental burs in the dental bur caddy 10 prior to opening. The body portion 12 preferably includes a series of body portals 36 disposed opposite the spanning member 28 of the handle portion 14. The body portals 36 allow ingress into the body portion 12 for disinfecting and drainage. The spanning member 28 is preferably concave, and thus the handle portals 34, in addition to allowing a user to identify the burs stored in the dental bur caddy, also allow ingress into the space under the handle portion 14 for disinfecting and drainage. When dental burs (not shown) are installed in the dental bur caddy 10 and the dental bur caddy 10 brought into the closed configuration as shown, the dental burs are disposed under the handle portion 14 and subject to cleaning and disinfecting therein.

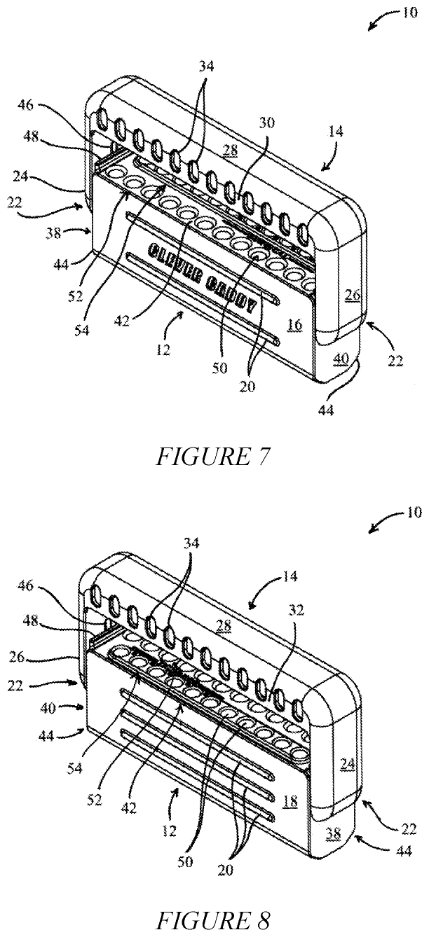

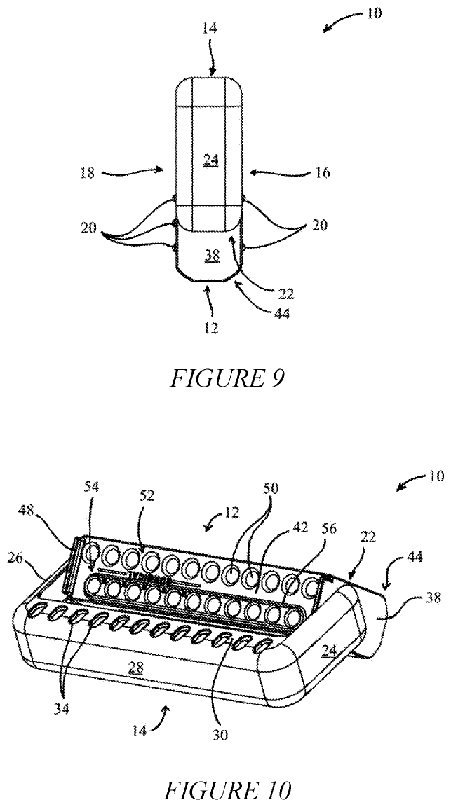

Referring now to FIGS. 7-9, the dental bur caddy 10 is shown in an open configuration. As seen in this view the handle portion 14 has been moved upward relative to the body portion 12. Exposing a first side 38, second side 40 and top portion 42 of the body portion 12. The first side 38 and the second side 40 each preferably have a rounded profile 42 corresponding to the rounded corners 22 of the first arm 24 and the second arm 26.

In one embodiment, the handle portion 14 moves relative to the body portion 12 via a slot 46 disposed in each of the first arm 24 and second arm 26. A tab 48 extending from the top portion 42 proximal the first arm 24 and second arm 26 is preferably sized to span the concave spanning member 28, thus locking the handle portion 14 in position when it is lowered over the body portion 12.

A series of bur holders 50 are disposed on the top portion 42 of the body portion 12. Preferably, the bur holders 50 are arranged in a first row 52 and a second row 54 of bur holders 50. In the illustrated embodiment, the second row 54 of bur holders 50 is slightly elevated to more easily access a selected dental bur, as well as to facilitate identification of the various dental burs installed in the dental bur caddy 10. Although the second row 54 is elevated in the illustrated embodiment, it should be understood that virtually any arrangement of elevated bur holders 50 is contemplated according to preference, as long as the position of the bur holders 50 permits closing of the handle portion 14 over the body portion 12.

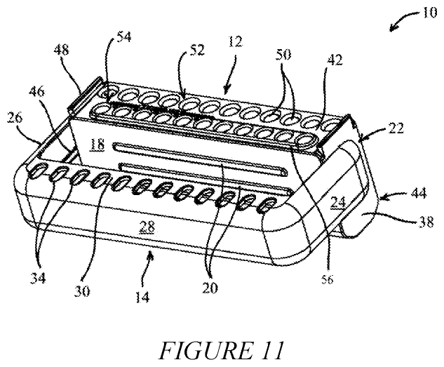

Referring to FIG. 10, the dental bur caddy 10 is shown in a first dispensing configuration. Preferably the slots 46 on the first arm 24 and the second arm 26 are configured such that the handle portion 14 can slide upward from the body portion 12 as shown in FIGS. 7-9, and can then be rotated relative to the body portion 12 in the manner shown. By rotating the body portion 12 relative to the raised handle portion 14, the top portion 42 of the body portion 12 is exposed, thereby exposing a series of dental burs and thus rendering them accessible for selection and use. Also shown in this view is the raised portion 56 characterizing the second row 54 on the top portion 42 of the body 12.

Referring to FIG. 11, the dental bur caddy 10 is shown in a second dispensing configuration. In the second configuration, the handle portion 14 has been slid upward as shown in FIGS. 7-9, rotated relative to the body portion 12 as shown in FIG. 10, but with the rotation having continued until the handle portion 14 functions as a rest or stand for holding up the body portion 12, and presenting the top portion 42 (and its associated dental burs) to a user.

The structure and features of the apparatus having been shown and described, its method of operation will now be discussed.

In order to use the dental bur caddy 10 of the present invention, a user first obtains the dental bur caddy 10 in a closed, clean, and ready to use configuration as is shown in FIGS. 1-6, with a plurality of dental burs installed therein. The user can then manipulate the handle portion 14 relative to the body portion 12, sliding it away from the body portion 12 along the slot 46. Facilitating this action are the hand grips 20 that allow a firm grasp on the body portion 12 and the handle portals 34 that allow a firm grip on the handle portion 14, as well as providing drainage and aeriation to the concave inside of the spanning member 28.

As the handle portion 14 slides away from the body portion 12, it clears the tabs 48 that would otherwise prevent it from rotating. Once the handle portion 14 is sufficiently distant from the body portion to clear the tabs 48 and the dental burs installed in the top portion 42, the handle portion 14 is rotated relative to the body portion 12 as shown in FIGS. 10 and 11. In the preferred embodiment, the handle portion 14 may be rotated in either direction relative to the body portion 12, and may be rotated sufficiently far away from the body portion 12 such that the handle portion 14 forms a resting stand capable of holding up the dental bur caddy 10 and orienting the dental burs toward a user for ease of grasping.

With the dental bur caddy 10 opened, the handle portion 14 rotated to form a stand, and the dental burs oriented according to preference, the dental bur caddy 10 may be placed on a surface for use. A user withdraws a particular dental bur from a bur holder on the top portion 42, and is able to identify an appropriate bur by its position in either the first row 52 or the second row 54. Since the second row 54 is elevated, it is easier to select among dental burs in different rows.

After use, the dental bur can be reinserted into the appropriate bur holder 50, and another dental bur selected. At the conclusion of a procedure, the dental burs may be cleaned and autoclaved prior to additional use. During cleaning and autoclaving, any moisture accumulating in the dental bur caddy 10 can exit through the handle portals 34 above the bur holders, and through the body portals 36 below the bur holder. Once the dental bur caddy 10 and dental burs therein have been cleaned, they may be re-used in the manner previously discussed.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An improved dental caddy for holding dental burs, the dental caddy comprising:
a body portion having a front face, an opposing rear face, the body portion coupled to a handle portion;
the handle portion having a spanning member between a first arm and an opposing second arm, the first arm and the second arm coupled to the body portion, the spanning member being concave in profile;
the body portion further comprising a first side and an opposing second side, wherein the first arm is coupled to the first side in a sliding and rotational configuration, and wherein the second arm is coupled to the second side in a sliding and rotational configuration;
the body portion further comprising a top portion having bur holders configured for holding the dental burs, and
a plurality of handle portals in the spanning member, each of the plurality of handle portals configured for viewing a dental bur in each of the bur holders, wherein due to the handle portion being configured to slide away from the body portion and rotate relative thereto, thereby a stand is formed for holding up the body portion and presenting exposed and accessible dental burs to a user.

2. The dental bur caddy of claim 1 wherein the first arm and the second arm are arranged substantially perpendicular to the spanning member.

3. The dental bur caddy of claim 1 wherein the first arm and the second arm are each as wide as the first side and the second side, respectively.

4. The dental bur caddy of claim 1 wherein the front face and the rear face each comprise hand grips.

5. The dental bur caddy of claim 1 further comprising a series of body portals in the body portion, the body portals disposed opposite the spanning member.

6. The dental bur caddy of claim 1 wherein the handle portion comprises rounded corners corresponding to rounded edges of the first side and second side.

7. The dental bur caddy of claim 1 further comprising at least one tab extending above the top portion and configured to span a concave portion of the spanning member.

8. The dental bur caddy of claim 1 wherein the first arm and the second arm each comprise a slot configured for allowing the body portion to simultaneously slide along each slot.

9. The dental bur caddy of claim 1 wherein the bur holders are arranged in rows, with one row elevated above the other row.

10. An improved dental caddy for holding dental burs, the dental caddy comprising:
a body portion and a handle portion, the body portion and the handle portion configured in a slidable relationship relative to each other and slidable between a closed configuration and an open configuration;
the body portion having a front face and an opposing rear face, and the handle portion having a front side and a rear side, the front side being adjacent the front face and the rear side being adjacent the rear face when the dental caddy is in the closed configuration;
the handle portion having a concave spanning member between a first arm and an opposing second arm, the first arm and the second arm coupled to the body portion;
the body portion further comprising a first side and an opposing second side, wherein the first arm is adjacent the first side and the second arm is adjacent the second side;
the body portion further comprising a top portion having bur holders configured for holding the dental burs, and
a plurality of handle portals in the spanning member, each of the plurality of handle portals configured for viewing a dental bur in each of the bur holders, wherein the handle portion is configured to slide away from the body portion and rotate relative thereto, thereby forming a stand for holding up the body portion and presenting exposed dental burs to a user.

11. The dental bur caddy of claim 10 wherein the first arm and the second arm are arranged substantially perpendicular to the spanning member.

12. The dental bur caddy of claim 10 wherein the first arm and the second arm are each as wide as the first side and the second side, respectively.

13. The dental bur caddy of claim 10 wherein the front face and the rear face each comprise hand grips.

14. The dental bur caddy of claim 10 further comprising a series of body portals in the body portion, the body portals disposed opposite the spanning member.

15. The dental bur caddy of claim 10 wherein the handle portion comprises rounded corners corresponding to rounded edges of the first side and second side.

16. The dental bur caddy of claim 10 further comprising at least one tab extending above the top portion and configured to span a concave portion of the spanning member.

17. The dental bur caddy of claim 10 wherein the first arm and the second arm each comprise a slot configured for allowing the body portion to simultaneously slide along each slot.

18. The dental bur caddy of claim 10 wherein the bur holders are arranged in rows, with one row elevated above the other row.

19. An improved dental caddy for holding dental burs, the dental caddy comprising:
a body portion slidably and rotatably connected to a handle portion;
the body portion having a top portion comprising a plurality of bur holders;
the handle portion having a concave spanning member configured to cover the top portion;
the handle portion slidable between a closed configuration, wherein the spanning member covers the top portion, thereby enclosing the dental burs, and an open configuration, wherein the dental burs are exposed;
the handle portion rotatable between a first position above the top portion, and a second position, wherein in the second position, the handle portion forms a stand configured to hold the top portion in an orientation selected by a user.

20. The dental bur caddy of claim 19, further comprising a plurality of handle portals in the spanning member, wherein each of the plurality of handle portals is configured for viewing a dental bur in each of the bur holders.
